(19) United States
(12) Patent Application Publication
(10) Pub. No.: US 2003/0069964 A1
(43) Pub. Date: Apr. 10, 2003

(54) Digital content catering system

(76) Inventors: Yevgeniy Eugene Shteyn, Cupertino, CA (US); Jan Renier Moonen, Sunnyvale, CA (US)

Correspondence Address: Corporate Patent Counsel, U.S. Philips Corporation, 580 White Plains Road, Tarrytown, NY, 10591, US

(21) Appl. No.: 09/971,474

(22) Filed: Oct. 4, 2001

(51) Int. Cl. G06F 15/173

(52) U.S. Cl. 709/225; 709/226

(57) ABSTRACT

Electronic content information is being catered via a data network. A consumer is enabled to request delivery via the network of a specific piece of content before a deadline selectable by the consumer. The catering service then completes the delivery before the deadline under control of a bandwidth profile of data traffic on at least a segment of the network. The scheduling of delivery deadlines enables the service to optimize usage of the network's bandwidth while maintaining a quality of service.

### FIELD OF THE INVENTION

The invention relates to a method of providing electronic information content via a data network. The invention also relates to consumer electronics (CE) equipment for use with the method, and to a user interface for the use with the method.

### BACKGROUND AND SUMMARY OF THE INVENTION

The Internet is designed for data traffic. The data traffic is characterized by bursts in the data flow. Different data packets from the same destination are sent individually to the destination and can follow different routes. The data traffic as a whole flows in irregular patterns across the network and at varying speeds in different regions of the network. In each burst a certain amount of information is transmitted and the average throughput at which the entire information is transmitted is the figure of merit.

On the other hand, the play out of audio or, more generally, the rendering of electronic content for media presentations, requires support for streaming data. Streaming is a technique for the transfer of data in such as way that it can be processed at the receiving end as a steady and continuous stream. Streaming technologies are becoming increasingly important with the growth of the Internet because the access that most users have is not fast enough for downloading large multimedia files in a short period of time. With streaming, the client browser or plug-in can start rendering the data before the entire file has been received. For streaming to work, the client receiving the data must be able to collect it and send it as a steady stream to the rendering application. This implies that if the data input to the client is faster than required for the rendering, the excess data needs to be buffered. If the data input is too slow, the rendering of the data will not be smooth.

Current audio/video (A/V) streaming solutions over the Internet, such as provided by RealAudio and WindowsMedia, offer only a partial solution to the problem of streaming files over the Internet. Especially for video, the bit-rate is relatively low, which results in a low quality of service and in a relatively poor image quality. Further, the effective size of the rendering is small compared to the screen real estate of a TV display monitor or of an average computer display monitor.

Currently, an increasingly large portion of bandwidth consumption on the Internet is for real-time content downloads. A problem is that service providers cannot control the demand for bandwidth, and therefore, cannot guarantee an acceptable quality of service. This owes to, among other things, the limited bandwidth available, and the unpredictability of the availability of the required bandwidth per individual consumer. For example, a two-hour digital video requires about 4 GBytes of compressed (e.g., MP2) data. The maximum download speed of a cable Internet connection is currently in the order of 4 Mbits/s. Therefore the minimum download time would be (4×1024×8)/(4×3600 sec)=2.4 hours. Realistic speeds in a multi-user systems are typically 3 to 5 times lower. In peak access times that could go even to 10 times lower.

The inventor provides a solution to this problem. In order to appreciate the invention, consider the following context.

One can discern certain trends in the CE environment regarding the Internet. One of the trends is that cable operators provide traditional AV services as well as Internet/network connectivity. The content has already been paid for by the cable operators.

Another trend is that the price per megabyte of digital storage (e.g.,on hard disk drives (HDD), optical disks or solid state) has been decreasing rapidly over the years. Large capacity HDDs (e.g., with a capacity greater than 20 Gigabyte) are being embedded in CE devices, such as personal video recorders with time warp functionality (e.g., TiVo), set-top boxes for cable and satellite receivers, etc. DVD-R/W and other high-capacity optical storage means are getting available on the market. Solid state memories, such as Flash cards, have become a commodity.

A further trend is that edge servers on a network are being moved closer to the physical location of the consumer and are capable of storing vast amounts of data at a close content distribution range. See, e.g., U.S. Ser. No. 09/844,570 (attorney docket US 018052) filed Apr. 26, 2001 for Eugene Shteyn for DISTRIBUTED STORAGE ON A P2P NETWORK ARCHITECTURE.

Yet another trend is that the integration of devices in a home network environment is also becoming increasingly more common. The HAVi architecture, the UPnP initiative, the Universal Serial Bus (USB), HomeRF Lite, and the Bluetooth standard, each involving substantial contributions from Philips Electronics, the Jini technology of Sun Microsystems, Inc., and others, have been developed to enhance the interoperability of multiple devices in a network. Via these control networks, or via point-to-point communications between devices, a user is enabled to conveniently access a variety of information and entertainment sources. See, e.g., U.S. Ser. No. 09/160,490 (attorney docket PHA 23,500) filed Sep. 25, 1998 for Adrian Turner et al., for CUSTOMIZED UPGRADING OF INTERNET-ENABLED DEVICES BASED ON USER-PROFILE; U.S. Ser. No. 09/189,535 (attorney docket PHA 23,527) filed Nov. 10, 1998 for Eugene Shteyn for UPGRADING OF SYNERGETIC ASPECTS OF HOME NETWORKS; U.S. Ser. No. 09/616,632 (attorney docket US 000184) filed Jul. 26, 2000 for Jean Moonen et al., for SERVER-BASED MULTI-STANDARD HOME NETWORK BRIDGING; U.S. Ser. No. 09/519,546 (attorney docket US 000014) filed Mar. 6, 2000 for Erik Ekkel et al., for PERSONALIZING CE EQUIPMENT CONFIGURATION AT SERVER VIA WEB-ENABLED DEVICE.

Yet another trend is that the Electronic Program Guide (EPG) has become a de-facto standard as a means for access to content within CE. The majority of consumers is very comfortable with selecting, recording and viewing content using it. See, e.g., U.S. Ser. No. 09/568,932 (attorney docket number US 000106) filed May 11, 2000 for Eugene Shteyn et al., for ELECTRONIC CONTENT GUIDE RENDERS CONTENT RESOURCES TRANSPARENT; and U.S. Ser. No. 09/823,658 (attorney docket US 018032) filed Mar. 29, 2000 for Jan van Ee for VIRTUAL PERSONALIZED TV CHANNEL.

Given the problems of fluctuating bandwidth availability and predictability, and given the above trends, the inventor proposes to provide high-quality video material via the Internet to the user at a low cost. The inventor further proposes a service model for better utilization of network bandwidth at a certain physical locale. The inventor proposes a digital catering service, which is implemented as an advanced reservation system for audio/video materials. The system enables the consumer to select, order and play-out digital audio/video materials, preferably via a suitable EPG interface. The interface and the selections are preferably customized for the user. The system preferably uses local storage capabilities, e.g., a STB, a TiVo, a PC, etc., to store the downloaded content. The head-end content servers and/or routers take advantage of the download scheduling information in order to predict demand, balance the network load and maximize the efficiency of the content distribution network. Edge network servers and peer-to-peer networking capabilities are preferably also used in peak and/or off-peak hours to provide additional caching and routing capabilities. Preferably, the service also offers a scheduled delivery of customized “special event” packages that include digital audio/video content. The service may also offer software packages that enable further content compression/decompression and distribution of the content within the local network, e.g., among wireless clients. Customers can be offered incentives to order content at their earliest convenience in a manner similar to airline and other advanced reservation systems.

More specifically, the invention relates to a method of catering content via a data network. The method comprises the steps of enabling to request delivery via the network of a specific piece of content for play-out by a certain time; and completing the delivery by the certain time under control of a bandwidth profile of data traffic on at least a segment of the network. The request is made by the consumer of the content, or another user, e.g., a content broker on the network or a segment thereof who specifies requests on behalf of a broadcast or a multicast within a community. The consumer may also specify to which address the specific content is to be delivered before the specified time. Within this context, see, e.g., U.S. Ser. No. 09/283,545 (attorney docket PHA 23,633) filed Apr. 1, 1999 for Eugene Shteyn for TIME- AND LOCATION-DRIVEN PERSONALIZED TV.

Preferably, different pieces of the content are offered that are selectable for completion of delivery at different times. Preferably, a menu is provided representing respective pieces of the content selectable for the delivery. For example, the menu is presented on a screen of a display monitor with a GUI familiar from EPGs. In order to select a piece for delivery, the user positions a highlight or cursor, or interacts with a touch screen, in the relevant part of the screen occupied by an indication or representation of the relevant piece. A drop down menu or other GUI element enables the user to select or otherwise specify the time and date of intended play-out. This information, i.e., data representative of the selected piece and of the intended play-out time and date, is then sent to the service provider, together with an identifier of this consumer, e.g., an IP address.

In an embodiment of the invention, the specific piece of content is requested by a specific consumer. The specific piece is then downloaded to an edge server in a proximity to the consumer, and the specific piece is offered for delivery to at least another consumer in the proximity of the edge server. The menu for the other consumer is modified to represent this option. This secondary offering from the edge server is a way to optimize network bandwidth usage and to increase revenues.

A higher price may be charged for delivery if the deadline specified is shorter. Knowing in advance the scheduled network load enables the service provider to balance the loads. Squeezing in last minute requests makes the balancing more difficult, up to the point that the requested delivery cannot be complied with.

A further tool for the service provider to optimize bandwidth usage is to encode a piece of content in manner that supports the scalability of play-out quality. For example, the piece of content is divided in multiple portions, each next portion representing a quality improvement when combined with a previous portion for play out. An example of such coding that supports this MPEG-4. As known, MPEG-4 enables to separate specific components of the content into different layers for separate compression. For example, visual components of video content can be separated in foreground and background that can be compressed individually for transmission. The background could be replaced by a truly static still frame for efficiency. MPEG-4 is an example of a wavelet-coding algorithm. Wavelets dynamically allow servers to reduce bitmap file sizes, thereby also affecting quality, when there is a need for lower bandwidth connections. This reduces the need to create different presentations to account for a variety of connection speeds.

To ensure a secure, and accounted for, distribution of content a digital rights management (DRM) system may be used with the content catering service of the invention. In some cases law requires implementation of such a system. For example, Digital Millennium Copyright Act (DMCA) prohibits gaining unauthorized access to a work by circumventing a technological protection measure put in place by the copyright owner, where such protection measure otherwise effectively controls access to a copyrighted work. Therefore, user content selection may depend on DRM capabilities of his/her rendering device and/or content storage configuration.

The service enables a consumer to render electronic content available from a server. The consumer specifies in advance what piece(s) of content is/are desired and by what date(s) and time(s). The content is selected from a pre-determined list or is ordered from a larger collection by the service provider. The service provider now is capable of optimizing delivery, quality of service, balancing the network load, and provide content specifically asked for. The provider uses the time period between the time of receipt of the request from the consumer and the time of desired rendering to schedule the download the relevant content in a manner that is able to take into account data traffic. The provider is able to control demand by pricing, or by offering for a certain price the content, that is scheduled for a particular party, to other subscribers in the vicinity of the edge server at the locale of the requesting consumer.

### BRIEF DESCRIPTION OF THE DRAWING

The invention is described in further detail, by way of example and with reference to the accompanying drawing, wherein:

FIG. 1 is a block diagram of a system in the invention; and

FIG. 2 is a flow diagram illustrating a scenario for user interaction with the system of the invention.

### DETAILED EMBODIMENTS

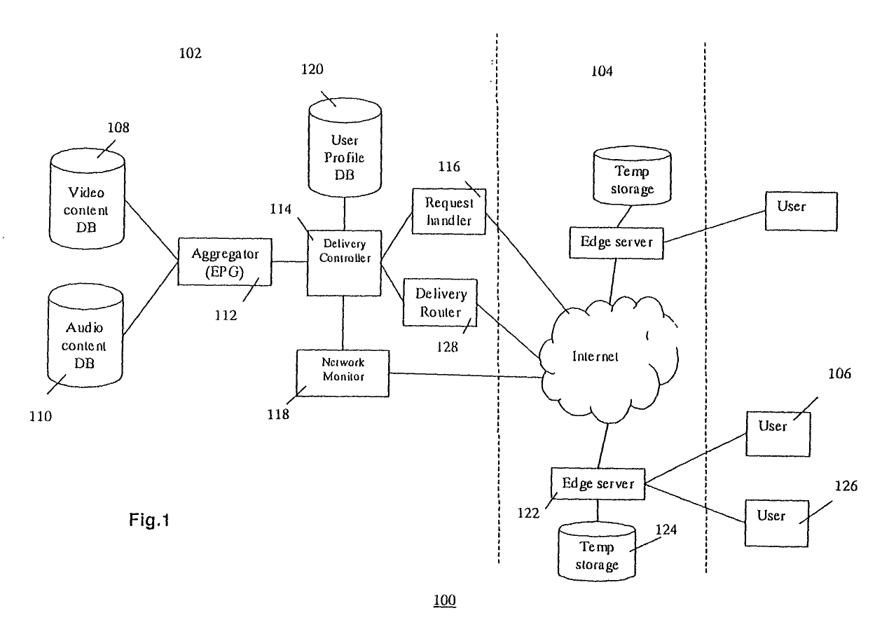

FIG. 1 is a block diagram of a system 100 in the invention. System 100 comprises a delivery preparation system 102, a transport network 104 and consumer equipment 106. System 102 comprises a video database 108 that comprises video content information, e.g., an inventory of movies in digital format. System 102 further comprises an audio database 110 that comprises audio content, e.g., music files in digital format. System 102 also comprises an aggregator 112 and a delivery controller 114. Aggregator compiles menus (e.g., similar to EPGs) for supply to consumer 106, e.g., via network 104. The menu indicates pieces of content, selectable by consumer 106, that are available for playing out at consumer's 106 in the near future. Assume that consumer 106 has selected a specific piece of content from the EPG and has made a reservation, via network 104, to have this piece available as of a certain point in time for play-out. System 102 has a request handler 116 for, upon receipt of the request, initializing the preparation of the requested content so that it will be available to this consumer before the deadline specified. Controller 114 consults with a network monitor 118 and with a user profile database 120. Monitor 118 monitors the traffic conditions on one or more specific segment(s) of network 104 that is/are relevant to delivery of content to consumer 106. From this, analysis is able to create a profile of the typical load of the segment(s) during a typical time period. User profile database 120 comprises the network address of consumer 106. From this, the relevant edge server 122 is known relevant to consumer 106. Based on the point in time specified by consumer 106 as the time for play-out, and based on the network conditions as determined by monitor 118, delivery controller 114 supplies the relevant content via edge server 122 to user 106 so that it gets there in time via a delivery router 128.

In case user 106 does not have a large enough storage locally, edge server 122 may cache the content in a memory 124 on behalf of the user and stream it when user 106 so desires. If edge server thus has received the content for user 106, another user 126 can be offered this same content in a menu adapted for the latter.

If bandwidth has been reserved on network 104 for the catering service of the invention, the monitoring of network conditions is largely replaced by controllably scheduling usage of the bandwidth available given the data traffic stemming from the supply of content upon previous requests. For example, the optimizing may be with respect to revenues. In this case, the service provider may need to optimize the price per download, given the quality of service, given the reservation time, and given the available bandwidth, all aggregated over the subscribing consumers. For example, a higher price is charged for a shorter time that the content has been reserved in advance and/or for higher quality content (e.g., in terms of higher or lower bit-rate, or in terms of complete show or highlights only of the content). Also, the EPG for consumers at the same edge server is adapted to show the content available as ordered by the specific consumer in above example. As another example, individual consumers are known by their individual network addresses. Their network addresses indicate their relevant network segment so that the data traffic relevant to that segment can be known in advance or estimated. These individual consumers are given individual menus of pieces of content for future play out that fit in certain time intervals. The intervals are distributed over time in a predetermined manner that enables optimization of bandwidth. This resembles a near-video-on demand cable service if it were not for the individual schedules for content. The individual schedules can be different for different consumers and reflect the controlled bandwidth usage.

Preferably, system 100 is integrated at least partly in a cable head end or satellite head end. For example, edge server 122 could be located at the cable head-end or satellite head end. As the cable or satellite service provider has usually already leased the content, and has a billing system in place, it makes sense to integrate the catering service with the content service in order to balance network load, optimize bandwidth usage and offer the consumer content within the same infrastructure.

The following user scenarios may clarify the concept.

Joe has a date scheduled for tomorrow and he wants to show off his new digital AV system. He picks up his BlueTooth cell phone and presses the EPG button. The cell phone communicates to the STB in his living room and displays the regular TV programming. Nothing looks really appealing. Then in the tomorrow's “special” section, Joe finds a romantic package, which could be available after 7 pm. Joe calls his girlfriend and together they select a movie he knows she really has wanted to see for some time. In addition, the package includes several “romantic evening” music play-lists. Joe reserves a couple of those just in case. He presses the “order”-button and he is guaranteed that the content will be available tomorrow evening. Also, the music play-lists can be available earlier for a preview and replaced, if necessary, in not more than 2 hours before the designated time. (At least one of the inventors insists that it is not a good idea to show off digital AV equipment to a date by playing out, e.g., downloaded pre-recorded sounds of classic motorcycles as a prelude to the movie “The Wild One” with Marlon Brando, so nothing is further said here about motorcycles. It is going to be their patent.)

Jan is a homemaker. Her new home improvement project is kitchen renovation. (The garage is already perfect for the hobby of her husband Jack. It has a refrigerator too). She knows that Jack will be in just the right mood to talk about that after the football game/motorcycle race on Sunday. However, she needs some planning and instruction materials to convince him. Jan turns on her TV and selects the extended EPG for the Home and Garden channel. There is 5 hours of instructional video content available for a kitchen renovation project, from planning to material purchasing. Jan orders the first part of the program to be available this Saturday for preview and the rest of it for Sunday. Since she is a regular customer, the system asks about her preferred configuration. See, e.g., U.S. Ser. No. 09/160,490 (attorney docket PHA 23,500), mentioned below, for further details. Jan selects two options: the living room (STB) and wireless PDA, just in case they would like to review the project by the pool side. In order to enable the PDA scenario, the system downloads MPEG-4 encoder/decoder software as well as an interface and communications application for Jack's 802.1 lb wireless network. The main content is stored on the STB. The network is UPnP compliant and the set-top box will present the program to the PDA control point as a UPnP content service when necessary.

The aforementioned scenarios can be implemented on the user side by utilizing HDD storage in the STB, TiVo, or a home server, etc. A DVD-RW can be used for the same purpose or for long-term storage. Preferably, a home network infrastructure is in place to provide communications between devices and application platform for a user interface as well as other applications. Users can interact with the EPG via a conventional remote control by navigating through grid supplied by a set-top box on a TV screen. Alternatively, a display-enabled device, such as Pronto remote control, PDA, cell phone, PC, and the like, can be used for the same purpose. An Internet web page can also be used to present the content (see, e.g., U.S. Ser. No. 09/568,932 (attorney docket US 000106) filed May 11, 2000 for Eugene Shteyn et al., for ELECTRONIC CONTENT GUIDE RENDERS CONTENT RESOURCES TRANSPARENT, mentioned in more detail below.

In the invention the service provider can gain economic value by better utilizing available network bandwidth. Digital content ordering system enables the provider to transition from reactive bandwidth allocation, e.g. at peak hours, to pro-active control of the network traffic. The back-end of the “digital catering” service comprises a combination of at least one of those: a content server, a bandwidth/delivery control means, a router and, optionally, an edge network server.

The content server stores digital content and provides data interfaces to the network. The bandwidth/delivery control means are enabled to calculate and optimize delivery time, based on the usual network usage pattern, pre-existing deliver orders, routing and caching options. The control means are also enabled to enforce bandwidth limitations on ad hoc (background, not ordered) content downloads within customary user limits. They can assign priorities to the content packets, so that the router can process such packets faster to guarantee timely delivery of the ordered content. The router is enabled to process data packets on a priority basis, especially during peak network traffic hours. A data cache can be used in combination with the router to avoid unnecessary loss of delayed lower-priority packets. The edge network storage server can be used to further optimize content delivery. Requests for the same content from a certain locale can be combined, and then the content can be transferred from the content to the edge network node closest to the locale. Then the content is delivered to individual clients at the locale at a pre-scheduled time.

An instantiation of the invention also includes software for a data processing apparatus, wherein the apparatus has a network interface for communicating with a data network. The software enables to render a user interface that in turn enables a user to request via a menu delivery via the network of a specific piece of content information. The user interface further enables the user to specify a deadline for the delivery of the specific piece of content information. An STB or PC, a universal programmable remote with touch screen functionality such as the Pronto of Philips Electronics, and also a cell phone or another communication apparatus may be enabled by installing this software so as to serve as the ordering interface with the service provider. The software may enable the user to select the deadline from a plurality of deadlines based on progressive pricing of the delivery for shorter deadlines. Deadlines may be pre-determined to facilitate selection without, e.g., manipulation of a keyboard at the apparatus.

Another instantiation relates to a communication apparatus with software for enabling to render a user interface. The user interface enables a user to select a specific piece of content from a menu; and the interface enables to control communication of a request for delivery of the specific piece of content information via a data network. The user interface also enables the user to communicate a deadline for the delivery of the specific piece of content information. This way, the user can set his preferences while on the move.

Yet another instantiation relates to a menu for supply to a consumer via a data network. The menu comprises identifiers of a plurality of pieces of content to enable the consumer to select of a specific piece of content for delivery via the data network before a deadline selectable by the consumer. Accordingly, the menu provides in a user-friendly way the options to choose from as well as means for specifying the desired deadline. The deadline may be selected from a plurality of pre-determined selectable deadlines, or may be entered via the menu into the system of the service provider as text via a keyboard or in a graphical manner by, e.g., sliding a bar along a time axis and/or date axis.

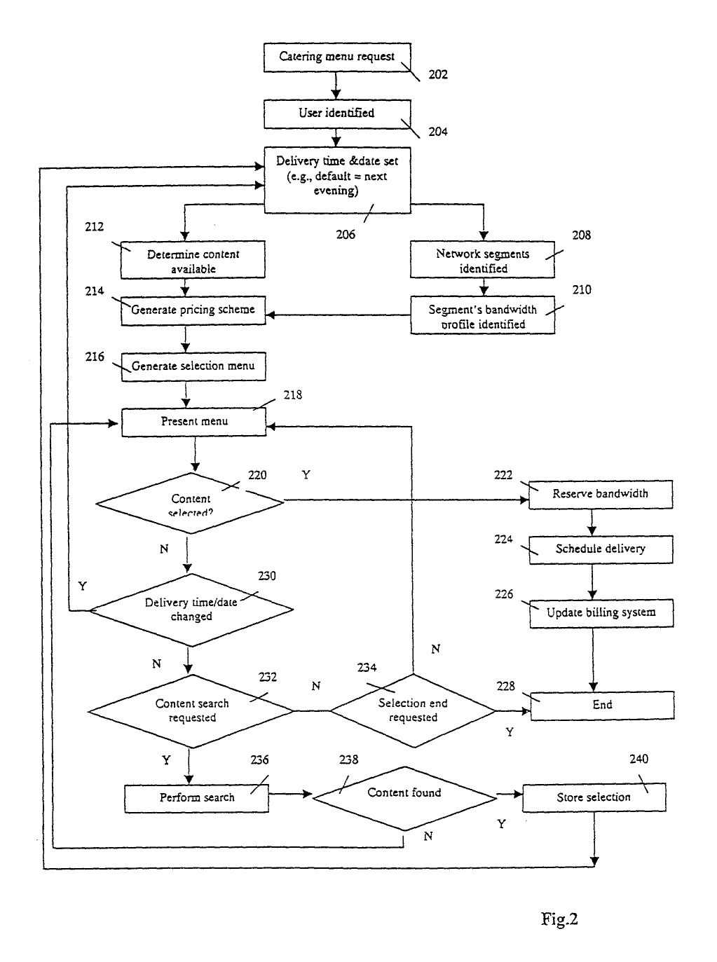

FIG. 2 is a flow diagram illustrating an example of a process to set up the user for delivery of content via the system, e.g., system 100. Part of the diagram is concerned with creation of a menu for the user as is explained as follows. In step 202, the user requests access to the content catering service. In step 204 the system checks the identity and profile of the requesting user to determine access options. For example, the user logs on to the system with a password that in combination with his/her IP address determines access. Alternatively, the access-requesting device, e.g., an STB, is identified using the manufacturer's serial number, and the proper user profile is retrieved by the system. In step 206 the system initializes the creation of the menu for this user by setting a default delivery time and day. This is based on, e.g., a history of user interaction or another profile attribute for this user, or on a “today's special” package prepared by the service provider. In step 208, the network segment(s) that are relevant to the content delivery is/are identified. In step 210 the bandwidth profile is determined for the segment(s) identified, e.g., based on history and/or forecast and/or reservation agreement. In step 212 the system determines the content available for this user, e.g., as based on the user's equipment, the bandwidth profile of the relevant network segments and the time set initially in step 206. The latter affects the menu through the temporary availability of content already stored on the edge servers as explained under FIG. 1. In step 214, a pricing scheme is created based on the available content, a range of dates and times for the user to choose from and the bandwidth profile. In step 216, the initial version of the selection menu is created, e.g., in the form of a topical electronic content guide (ECG, see U.S. Ser. No. 09/568,932 (attorney docket US 000106)) or an EPG, that is presented to the user in step 218. If the user selects, in step 220, from the content in the initial menu at the times pre-set and at the prices given, the system reserves the bandwidth for this user in step 222. The system schedules the delivery of this content in step 224, updates the billing system for this user in step 226 and ends the set-up process in step 228. If the user wants to modify the menu regarding the deadline for delivery and/or the content from which to select, the process goes to step 230. In step 230, the user has the option to select another time and/or date for delivery of the proposed content. If the user merely changes the time and/or date, the process goes back to step 206 as the change in time may affect the bandwidth conditions, the content available for selection, and therefore the pricing. The system traverses steps 208-216, as specified above, and presents to the user a modified menu from which the user can select. If the user agrees makes a selection from this menu, the process proceeds to step 222 and from there to end 228. If the user indicates he/she wants to change the time and/or the content, the system proceeds to step 230. From step 230, the return to step 206 is an option to again change the time again, or the option to step 232, wherein to determine whether or not to search for further content. If the user decides not to do a search, the user may return to the previous menu (of step 218) from step 234 or go to end 228. If the user decides to request a search for further content, the process continues to step 236 wherein a search is performed via proper user input, e.g., through keywords or genre. Upon finding desired new content in step 238, the selection is stored and the process goes to step 206. If the user does not find anything to his/her linking, the system informs the user of the results and returns to step 218.

Herein incorporated by reference:

U.S. Ser. No. 09/844,570 (attorney docket US 018052) filed Apr. 26, 2001 for Eugene Shteyn for DISTRIBUTED STORAGE ON A P2P NETWORK ARCHITECTURE. This document relates to an electronic content delivery system uses a network of end-user devices around a hub. Each end-user device has storage capability. Content is stored in a distributed fashion on the network of these end-user devices for being made available to individual ones of these devices in a P2P fashion so as to cut download time and reduce transmission errors. The local storage at the individual end-user devices is preferably not under control of the relevant end-user.

U.S. Ser. No. 09/568,932 (attorney docket US 000106) filed May 11, 2000 for Eugene Shteyn et al., for ELECTRONIC CONTENT GUIDE RENDERS CONTENT RESOURCES TRANSPARENT. This document relates to a data management system on a home network collects data that is descriptive of content information available at various resources on the network. The data is combined in a single menu to enable the user to select from the content, regardless of the resource.

U.S. Ser. No. 09/160,490 (attorney docket PHA 23,500) filed Sep. 25, 1998 for Adrian Turner et al., for CUSTOMIZED UPGRADING OF INTERNET-ENABLED DEVICES BASED ON USER-PROFILE. This document relates to a method of enabling customizing a technical functionality of network- (e.g., Internet-) enabled equipment of an end-user. According to the method a profile of the end-user and information about a technical feature for use with the equipment are stored at a server system. Based on the user-profile it is determined whether or not the user should be notified about the availability of this feature. If it has been decided that there is a match between the user profile as stored and the information about this feature, the end-user gets notified via the network of the option to obtain the feature for being added to his/her equipment. In case the feature relates to new software, it can be downloaded via the network for preferably automatic installation in the equipment. In case the feature comprises a hardware component, it can be shipped to the end-user upon acceptance of the offer. A helpdesk is preferably provided through the network to help the end-user install the feature. This concept is based on the insight that network-enabled equipment will become a flexible repository into which the end-user can place new and exciting features over time dependent on the user's needs or desires, context of use, advancement of technology, etc. Not all end-users are always interested in all possible features for creating enhanced functionality of the equipment. Accordingly, a user-profile is established, either when the user registers his equipment with the notification service, or dynamically as a consequence of the user's interaction with the server system, or through a combination thereof. The profile is used to select technical features that are likely of interest to the user. In this manner, the user is kept abreast of the latest trends of interest to him/her. This service implicitly supports virtual recycling as equipment needs to be designed for the purpose of being upgraded. The modular approach of adding or deleting technical software or hardware features as needed thus assists in slowing down the trend that products becoming obsolete fairly quickly, but without barring the manufacturer or aftermarket sales organizations from continuing doing business. This service is specifically relevant to vertical markets. A vertical market is a particular branch of commercial activity for which similar products or similar services are relevant. Examples of vertical markets are education, offices, hotels, consumers, hospitals, etc. Each of these segments have unique requirements for hardware devices and their functionality. Hardware manufacturers can make their devices more relevant to a specific vertical market segment by combining a relevant set of applications and services.

U.S. Ser. No. 09/189,535 (attorney docket PHA 23,527) filed Nov. 10, 1998 for Eugene Shteyn for UPGRADING OF SYNERGETIC ASPECTS OF HOME NETWORKS. This document relates to a server that has access to an inventory of devices and capabilities on a user's home network. The inventory is for example a look-up service as provided by HAVi or Jini architecture. The server has also access to a database with information of features for a network. The server determines if the synergy of the apparatus present on the user's network can be enhanced based on the listing of the inventory and on the user's profile. If there are features that are relevant to the synergy, based on these criteria, the user gets notified.

U.S. Ser. No. 09/616,632 (attorney docket US 000184) filed Jul. 26, 2000 for Jean Moonen et al., for SERVER-BASED MULTI-STANDARD HOME NETWORK BRIDGING. This document relates to a bridge in a home network that couples first and second clusters of devices. The clusters have different software architectures. The bridge is connected to a server on the Internet. This server offers a lookup service for some set of standards, and allows a bridge to locate and download the appropriate translation modules for allowing a device in the first cluster to interact with the second cluster.

U.S. Ser. No. 09/519,546 (attorney docket US 000014) filed Mar. 6,2000 for Erik Ekkel et al., for PERSONALIZING CE EQUIPMENT CONFIGURATION AT SERVER VIA WEB-ENABLED DEVICE. This document relates to the facilitating the configuring of CE equipment by the consumer by means of delegating the configuring to an application server on the Internet. The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

U.S. Ser. No. 09/823,658 (attorney dot US 018032) filed Mar. 29, 2001 for Jan van Ee for VIRTUAL PERSONALIZED TV CHANNEL. This document relates to a data management system that creates a personalized content information channel for an end-user by enabling to automatically play out a plurality of concatenated content information segments. These segments or programs have been selected on the basis of a criterion independent of a respective resource of respective ones of the segments. Resources include a TV for live broadcasts, a HDD-based video recorder for recorded TV programs, a DVD player, a CD player, solid state MP3 players, a PC and other sources on a home network suitable for delivering of audio, video, still picture or graphics content information.

U.S. Ser. No. 09/283,545 (attorney docket PHA 23,633) filed Apr. 1, 1999 for Eugene Shteyn for TIME- AND LOCATION-DRIVEN PERSONALIZED TV. This document relates to a server system that enables a subscriber to select a specific broadcast program for recording and a specific location and time frame for play-out of the recorded program. The document also relates to a method that enables the user to select the content information, e.g., from an electronic program guide relating to a broadcast or multicast service. The selected content information gets recorded when it is broadcast or multicast. The method enables the user to select in advance at least a specific one from multiple geographically different locations at which the recorded, selected content information will be made available for play-out.

What is claimed is:

1. A method of catering content via a data network, the method comprising:
enabling to request delivery via the network of a specific piece of content before a selectable deadline; and
completing the delivery before the deadline under control of a bandwidth profile of data traffic on at least a segment of the network.

2. The method of claim 1, comprising offering different pieces of the content that are selectable for completion of delivery by different deadlines.

3. The method of claim 1, comprising providing a menu of respective pieces of the content selectable for the delivery.

4. The method of claim 1, wherein the specific piece of content is requested by a specific consumer, the method comprising:
downloading the specific piece to an edge server in a proximity to the consumer; and
offering the specific piece for delivery to at least another consumer in the proximity of the edge server.

5. The method of claim 1, comprising charging a higher price for delivery before a shorter deadline.

6. The method of claim 3, comprising:
adapting the menu based on the specific piece of content scheduled for delivery via an edge server to a first consumer; and
providing the menu to a second consumer in a proximity of an edge server.

7. The method of claim 1, comprising encoding the piece with scalable play-out quality.

8. The method of claim 1, comprising offering a package of multiple pieces of content for delivery via the network before the selectable deadline.

9. The method of claim 1, wherein the data network comprises a cable network.

10. Software for a data processing apparatus, wherein:
the apparatus has a network interface for communicating with a data network;
the software enables to render a user interface;
the user interface enables a user to request via a menu a delivery via the network of a specific piece of content information;
the user interface enables the user to specify a deadline for the delivery of the specific piece of content information.

11. The software of claim 10, enabling the user to select the deadline from a plurality of deadlines based on progressive pricing of the delivery for shorter deadlines.

12. A communication apparatus comprising:
software for enabling to render a user interface; wherein:
the user interface enables a user to select a specific piece of content from a menu;
the interface enables to communicate a request for delivery of the specific piece of content information via a data network;
the user interface enables the user to communicate a deadline for the delivery of the specific piece of content information.

13. A menu for supply to a consumer via a data network, wherein the menu comprises identifiers of a plurality of pieces of content to enable the consumer to select of a specific piece of content for delivery via the data network before a deadline selectable by the consumer.
